(19) United States
(12) Patent Application Publication
(10) Pub. No.: US 2015/0100187 A1
(43) Pub. Date: Apr. 9, 2015

(54) METHOD OF OPERATING AN ELECTRIC OR HYBRID VEHICLE

(71) Applicant: FORD GLOBAL TECHNOLOGIES, LLC, Dearborn, MI (US)

(72) Inventors: Brian Richard Light, Flat Rock, MI (US); Jonathan Andrew Butcher, Farmington, MI (US); Daniel Richard Luedtke, Beverly Hills, MI (US); Darko Acevski, Sterling Heights, MI (US); Carlos Ayala, Novi, MI (US); Shailesh Shrikant Kozarekar, Novi, MI (US)

(73) Assignee: FORD GLOBAL TECHNOLOGIES, LLC, Dearborn, MI (US)

(21) Appl. No.: 14/045,845

(22) Filed: Oct. 4, 2013

(51) Int. Cl. B60L 11/08; B60W 20/00

(52) U.S. Cl. CPC B60L 11/08; B60W 20/10; Y10S 903/906
USPC 701/22; 180/65.285; 903/906

(57) ABSTRACT

A method of controlling a motor in a hybrid electric vehicle mitigates the risk of an incorrectly wired or incorrectly connected wiring harness. Following the connection or re-connection of a wiring harness, the vehicle responds to a torque request by limiting the magnitude of the motor torque until the proper direction of torque is confirmed. A flag is then set to record that torque direction has been confirmed so that the vehicle can respond normally to future requests. Several events may indicate that a wiring harness has been re-connected.

### TECHNICAL FIELD

This disclosure relates to the field of control of electric machines. More particularly, this disclosure relates to a fault mitigation strategy for electric traction motors in vehicle applications.

### BACKGROUND

Hybrid electric vehicles utilize one or more electric motors in addition to an internal combustion engine to propel the vehicle. The electric machine improves fuel economy by capturing braking energy, eliminating the need to run the engine at all during certain operating conditions, and supplementing engine torque during acceleration, thus allowing a smaller engine for a given vehicle size. A driver operates a hybrid electric vehicle in the same manner as a non-hybrid vehicle and expects the same level of safety.

To maximize efficiency, inverter-fed three phase alternating current (AC) motors are common. Three separate electrical power connections are required between an inverter and the motor, one for each phase. Additional signal connections are also needed. To produce a desired torque, a controller commands the inverter to generate voltages for each phase that are coordinated with the position of the rotor. For convenience of assembly, the wires that establish the power and signal connections are often bundled into wiring harnesses. If the wires are mis-connected, the motor may produce no torque or may even produce torque in the direction opposite of the desired direction. Incorrect torque direction may result in incorrect direction of motion of the vehicle.

### SUMMARY OF THE DISCLOSURE

In one embodiment, a hybrid electric vehicle includes an electric motor connected to an inverter by a wiring harness and a controller programmed to issue commands to the inverter. In response to a signal indicating a desired direction and magnitude of force, the controller is programmed to command the inverter to generate a substantially lower force until correct direction of force is confirmed and then to command the inverter to generate the desired force. The controller may also record that correct direction has been confirmed and respond to subsequent signals without repeating the confirmation. Re-confirmation may be triggered by clearing of fault codes or by sensing a wiring harness service tool. Confirmation may be accomplished, for example, by position sensors of a vehicle driveshaft or some other shaft in the powertrain.

A controller includes input channels, output channels, and control logic in another embodiment. The input channels receive data indicating a desired direction and magnitude of motor torque. The output channels send commands to an inverter to adjust the magnitude and direction of motor torque. The control logic responds to the data by commanding a torque of a magnitude substantially less than the desired magnitude, then confirming that a torque in the desired direction has been applied, then commanding a torque of the desired magnitude. The control logic may also be programmed to set a flag indicating that the torque direction has been confirmed and to command the desired torque without re-confirming torque direction when the flag is set. The flag may be unset by, for example, clearing service codes or using a wiring harness service tool. Confirmation may be accomplished, for example, by position sensors of a vehicle driveshaft or some other shaft in the powertrain.

In another embodiment, a method of operating an electric vehicle, such as a hybrid electric vehicle, following connection of a wiring harness includes responding to a torque demand for a motor by commanding the motor to apply a torque of substantially reduced magnitude and then commanding the motor to apply a torque of the desired magnitude after confirming that the torque is being applied in the correct direction. The method may also include setting a flag after confirming the torque direction and responding to subsequent requests by commanding the desired torque without first confirming correct direction.

### BRIEF DESCRIPTION OF THE DRAWINGS

FIG. 1 is a schematic representation of an example hybrid electric vehicle powertrain.

FIG. 2 is a flow chart for a motor control algorithm.

FIG. 3 is a flow chart for an auxiliary algorithm associated with the motor control algorithm of FIG. 2.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

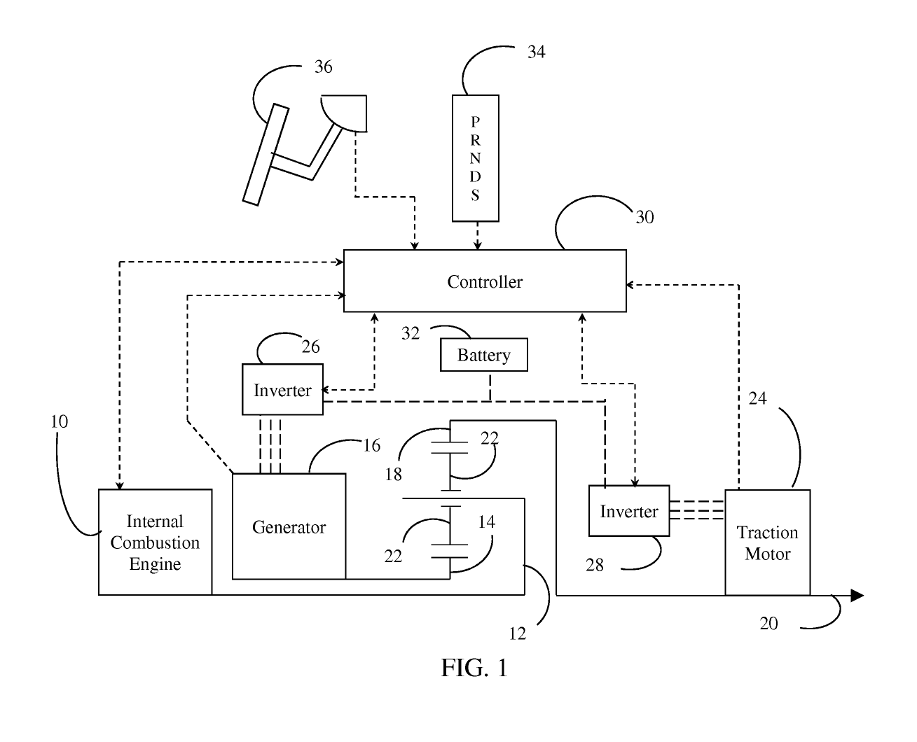

FIG. 1 illustrates a hybrid electric powertrain configuration. Mechanical connections among components are illustrated by solid lines, electrical power connections are illustrated by lines with long dashes, and electrical signals are illustrated by lines with short dashes. Primary motive power is provided by internal combustion engine 10 which drives the carrier 12 of a planetary gear set. The sun gear 14 of the planetary gear set drives generator 16. The ring gear 18 of the planetary gear set drives the output shaft 20. The output shaft 20 drives the vehicle wheels. A set of planet gears 22 is supported for rotation with respect to carrier 12 such that each planet gear meshes with both sun gear 14 and ring gear 18. Traction motor 24 drives output shaft 20.

Generator 16 and traction motor 24 are each reversible electrical machines. Each reversible electric machine has an associated inverter that provides three phase alternating current power. The magnitude and direction of the torque produced by the electric machine is dictated by the magnitude, frequency, and phase angle of the voltage in each of the three conductors relative to the angular position of the respective rotor. Inverters 26 and 28 regulate the voltage in each conductor based on commands from controller 30. Controller 30 utilizes signals from rotor position sensors in the generator and traction motor to compute these commands. Electrical power flows between the inverters and to or from battery 32 through a direct current electrical connection.

When the output shaft is stationary or rotating slowly, the planetary gear set divides the power from the engine between the output shaft and the generator. The power that goes to the generator is then transmitted electrically from the generator to the motor which mechanically drives the output shaft. When the output shaft is rotating fast, the planetary sun gear rotates in the opposite direction and power is transmitted electrically from the traction motor to the generator. In some operating conditions, the battery supplements the power provided by the internal combustion engine. In other operating conditions, power flows into the battery.

The driver indicates his or her desired direction of travel by manipulating range selector 34. The driver indicates the magnitude of the desired tractive force by depressing accelerator pedal 36. The range selector and accelerator pedal transmit information to controller 30 via signal communication channels. Controller 30 combines data from these sensors with data from speed sensors to determine a desired torque magnitude and direction for engine 10, generator 16, and traction motor 24. The controller adjusts the torque of engine 10 by issuing commands to the engine to control throttle position, spark timing, fuel flow, etc. The controller adjusts the torque of generator 16 and traction motor 24 by issuing commands to inverters 26 and 28 respectively.

The wiring that establishes the electrical power connections and signal connections may be assembled into one or more wiring harnesses. Multiple conductor electrical connectors on the various components mate with corresponding multiple conductor electrical connectors on the wiring harness. If the wiring harness is mis-wired or if one of the connections is made incorrectly, then improper connections are established. Such improper connections can result in the generator or motor producing torque that differs from what the controller commands. In particular, reversal of two of the connectors in a three phase power connection can result in a torque equal in magnitude to the desired torque but opposite in direction. If this occurs, the vehicle may move in a direction opposite the driver's intention as indicated by the range selector. Other types of mis-wired connection result in the electrical machine producing no torque when torque is commanded.

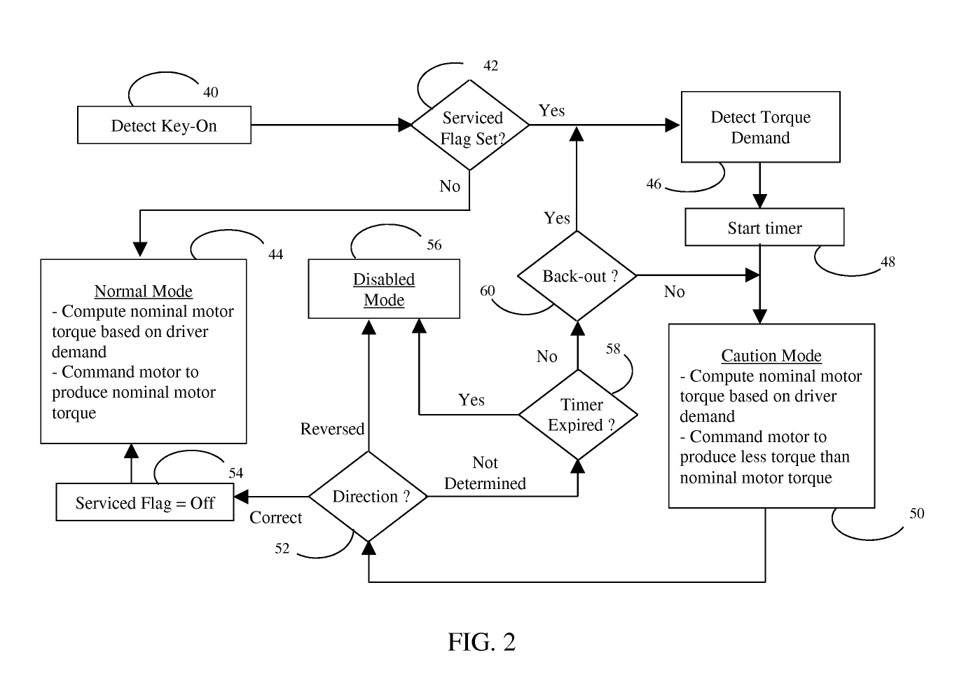

FIG. 2 illustrates a method for mitigating the potential impact of improper motor torque direction that could result from a mis-wired or mis-connected wiring harness. The method begins at 40 when the controller first detects a key-on condition indicating that the driver is ready to move. At 42, the controller checks the status of a flag that is set whenever the wiring harness may have changed since the vehicle was last operated. If the flag is not set, indicating that the wiring has not changed, the controller proceeds immediately to 44 and operates the vehicle as discussed above. If the flag is set, indicating that the wiring might have changed, the controller proceeds to 46.

At 46, the controller waits for the driver to position the range selector and accelerator pedal to indicate a demand for wheel force. Once such a command for torque greater than a first threshold is detected, the controller starts a count-down timer at 48. While the timer is running, the controller controls the motors in a caution mode at 50. In caution mode, the controller commands motor torque in the same direction as the driver request but of substantially lower magnitude. At 52, the controller attempts to determine the actual direction of torque based on feedback from position sensors. If the direction is determined to be correct, then the controller unsets the flag at 54 and transitions to normal control at 44. If the direction is determined to be reversed, the controller goes into a disabled mode at 56. If the position has not changed by enough to conclude the direction of torque, then the controller checks the timer at 58. The amount of time associated with the timer is calculated to be long enough that the vehicle should move a detectable distance in the correct direction if the motor is producing torque in the correct direction. If the timer has expired, then the controller goes into disabled mode at 56. If the time period has not yet elapsed, the controller re-checks the driver torque command at 60. If the torque command has dropped below the threshold value, which is called a back-out, the controller returns to 46 and waits for the demand to again exceed the threshold, at which time the timer will be reset. If the demand continues to be above the threshold, the controller continues in caution mode at 50 and continues attempting to confirm the direction of torque.

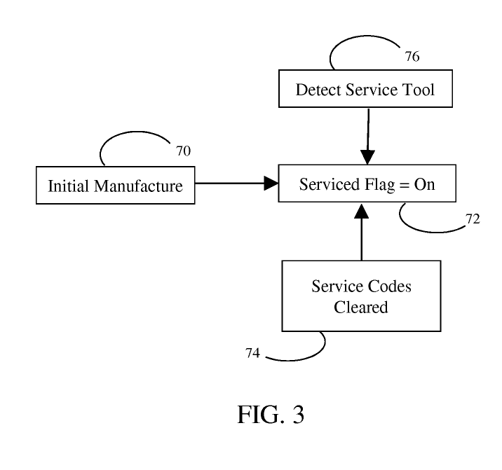

FIG. 3 indicates some of the ways that the flag can be set to indicate that a mis-connection or mis-wired condition is possible. As shown at 70, initial manufacture of the vehicle is one situation that justifies setting the flag at 72. Whenever the controller senses conditions that are potentially problematic, the controller may set service codes in memory that help service personnel diagnose the potential problem. After service personnel have made a repair, they often clear the service codes. Therefore, as indicated at 74, clearing of service codes is an indication that the vehicle may have been recently serviced which may have involved disconnecting and reconnecting the wiring harness. Some types of electrical connectors require special tools to connect or disconnect. In some cases, the controller can sense the presence of such tools. As shown at 76, the presence of such a service tool is another indicator that the wiring harness may have been disconnected and reconnected. These examples are not intended to be exhaustive.

The above process mitigates the safety implications of an incorrect power connection or an incorrect signal connection. Because a reduced torque is commanded until proper direction is confirmed, any damage that might result will be correspondingly reduced. More importantly, the vehicle will enter a disabled mode after moving only a short distance in the incorrect direction. The flag limits any degradation of performance associated with the process to the rare situations in which the wiring could potentially be incorrect.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A hybrid electric vehicle comprising:
an electric motor configured to apply a force to propel the vehicle in either a forward direction or a reverse direction;
an inverter configured to provide three phase alternating current power;
a wiring harness establishing a three phase alternating current power connection between the inverter and the electric motor; and
a controller programmed to respond to a signal indicating a desired force magnitude and direction corresponding to a desired vehicle movement direction by
commanding the inverter to generate three phase alternating current such that the electric motor applies a first force having a first magnitude substantially less than the desired magnitude, and
in response to confirmation that the force is being applied in the desired direction, commanding the inverter to generate three phase alternating current such that the electric motor applies a second force having a second magnitude substantially equal to the desired magnitude.

2. The hybrid electric vehicle of claim 1 wherein the controller is further configured to:
record that a correct three phase power connection has been confirmed; and
respond to subsequent signals indicating the desired force magnitude and direction by commanding the inverter such that the motor applies the second force without again applying the first force.

3. The hybrid electric vehicle of claim 2 wherein the controller is further programmed to:
respond to clearing of service codes by recording that a correct three phase power connection should be reconfirmed; and
then respond to a subsequent signal indicating the desired force magnitude and direction by commanding the inverter such that the motor again applies the first force until force direction is again confirmed.

4. The hybrid electric vehicle of claim 2 wherein the controller is further programmed to:
respond to the presence of a service tool used to remove or install the wiring harness by recording that a correct three phase power connection should be reconfirmed; and
then respond to a subsequent signal indicating the desired force magnitude and direction by commanding the inverter such that the motor again applies the first force until force direction is again confirmed.

5. The hybrid electric vehicle of claim 1 further comprising a position sensor in communication with the controller, wherein application of the second force is delayed until a signal from the position sensor indicates vehicle movement in the desired direction.

6. The hybrid electric vehicle of claim 1 further comprising:
a planetary gear set having three planetary elements including a sun gear, a ring gear, and a carrier;
an internal combustion engine driveably connected to a first element of the planetary gear set;
a generator driveably connected to a second element of the planetary gear set; and
wheels drivably connected to a third element of the planetary gear set and also driveably connected to the electric motor.

7. A controller comprising:
channels configured to receive data indicating a desired torque magnitude and direction; and
a processor configured to respond to the data by sending commands to produce a torque in the desired direction of a magnitude substantially less than the desired magnitude, and to respond to confirmation that the torque is being applied in the desired direction by sending commands to produce a torque of the desired magnitude.

8. The controller of claim 7 the processor is further configured to:
set a flag to indicate that the torque direction has been confirmed since the most recent connection of a wiring harness; and
respond to the data while the flag is set by sending commands to produce a torque of the desired magnitude without re-confirming that a torque in the desired direction is being applied.

9. The controller of claim 8 wherein the controller is further configured to unset the flag in response to service codes being cleared.

10. The controller of claim 8 wherein the controller is further configured to unset the flag in response to a service tool being used to install or remove the wiring harness.

11. The method of claim 7 wherein confirmation that the torque is being in the desired direction is based on signals from a position sensor.

12. A method of operating an electric vehicle following connection of a wiring harness, the method comprising:
in response to a torque demand for a motor of a specified direction and magnitude, commanding the motor to apply a torque of a magnitude substantially less than the specified magnitude; and
after confirming that the torque is being applied in the specified direction, commanding the motor to apply a torque of the specified magnitude.

13. The method of claim 12 further comprising:
after confirming that the torque is being applied in the specified direction, setting a flag; and
in response to a subsequent torque request for the motor while the flag is set, commanding the motor to apply a torque of the specified magnitude without first applying a torque of a substantially lower magnitude.

14. The method of claim 12 further comprising unsetting the flag in response to the presence of a service tool used to install or remove a wiring harness.

15. The method of claim 12 further comprising unsetting the flag in response to clearing of service codes.

16. The method of claim 12 wherein confirmation that the torque is being applied in the specified direction is based on signals from a position sensor.

17. The method of claim 12 wherein the vehicle comprises:
a planetary gear set having three planetary elements including a sun gear, a ring gear, and a carrier;
an internal combustion engine driveably connected to a first element of the planetary gear set;
a first motor driveably connected to a second element of the planetary gear set; and
a second motor drivably connected to a third element of the planetary gear set and also driveably connected to vehicle wheels.

18. The method of claim 17 wherein the commands are issued to the first motor.

19. The method of claim 17 wherein the commands are issued to the second motor.
